(19) United States
(12) Patent Application Publication
(10) Pub. No.: US 2005/0105684 A1
(43) Pub. Date: May 19, 2005

(54) Virtual two-dimensional detector

(75) Inventors: Lutz Bruegemann, Durmersheim (DE); Ekkehard Gerndt, Karlsruhe (DE); Heiko Ress, Karlsruhe (DE); Kurt Helming, Dresden (DE); Uwe Preckwinkel, Fitchburg, WI (US)

Correspondence Address: KUDIRKA & JOBSE, LLP, ONE STATE STREET, SUITE 800, BOSTON, MA, 02109, US

(73) Assignee: Bruker AXS Gmbh, Karlsruhe (DE)

(21) Appl. No.: 10/927,427

(22) Filed: Aug. 26, 2004

(30) Foreign Application Priority Data
Aug. 30, 2003 (DE) 103 40 072.9

(51) Int. Cl. G01N 23/20; G01J 3/28

(52) U.S. Cl. 378/71

(57) ABSTRACT

A detector arrangement for detecting X-ray or neutron radiation redirected from a sample makes use of a one-dimensional particle or photon counting detector. The detector is oriented along a direction that is disposed substantially perpendicularly to a straight line extending between the sample and the detector. The detector may be rotated within the detection plane to allow inexpensive acquisition of two-dimensional diffraction patterns without the use of a two-dimensional detector.

### FIELD OF THE INVENTION

The invention concerns a detector arrangement for detecting X-ray or neutron radiation scattered from a sample.

### BACKGROUND OF THE INVENTION

X-ray and neutron scattering are important methods of structural analysis. The diffraction of the X-ray or neutron radiation provides information about the symmetry properties of the scattering (usually crystalline) material.

Various detectors are used to acquire diffraction patterns. So-called zero-dimensional detectors are most common. They recognize penetration of an X-ray quantum into a small detection space. To obtain a complete diffraction pattern, the zero-dimensional detector is displaced along an approximately circular arc in a diffractometer using a goniometer for a theta-2theta-scan or within a two-dimensional grid for detecting a two-dimensional diffraction image.

A one-dimensional detector has a detection space which extends in one dimension (detector path). If an X-ray quantum falls into the detection space, the one-dimensional detector detects this occurrence as well as the position along the detector path. A one-dimensional detector permits simultaneous detection of larger parts of a diffraction pattern. A one-dimensional detector may conventionally be displaced through pivoting of a goniometer arm to obtain a new solid angle region to be measured. One-dimensional detectors are considerably more expensive than zero-dimensional detectors.

Two-dimensional detectors generally have a flat, two-dimensional detector surface. An X-ray quantum which impinges on the detector surface is registered as an event and its two spatial coordinates on the detector surface are also registered. A physically two-dimensional detector can produce a diffraction pattern in one single measuring step. Two-dimensional detectors are also considerably more expensive than one-dimensional detectors.

There are also conventional two-dimensional storage plates in which X-ray radiation is integrated and which are read-out using a laser-supported evaluation process. Photographic films are still used to obtain maximum resolution for X-ray diffraction pattern acquisition.

### SUMMARY OF THE INVENTION

The present invention introduces a detector arrangement for X-ray or neutron radiation which permits acquisition of two-dimensional diffraction patterns with little cost and at an acceptable speed. The invention makes use of a detector arrangement in which the detector can be rotated about an axis parallel to the diffraction direction. The detector may comprise a one-dimensional, particle or photon counting detector, which is oriented along a detector path, wherein the detector path is disposed substantially perpendicularly to a straight line extending between the sample and the detector (scattering direction). The detector path can thereby sweep, perpendicularly to the diffraction direction, through a circular surface having a diameter of at least the length of the detector path.

If the pivot point about which the detector is rotated is at one end of the detector path, the diameter of the circular surface may be twice as large as the detector path. The inventive detector arrangement then typically provides a three-dimensional parameter set for a measuring time interval, which consists of: number of events (or counting rate)/location along the detector path/angle position of the detector path. The angle position may thereby preferably be automatically and electronically set and detected or be manually set by the operator. A position within the circular surface can be determined from the parameters of location along the detector path and the angular position of the detector path. After measurement at a plurality of angular positions (with grid or also with continuous rotation), the detector arrangement can be used for detection within the circular surface. The one-dimensional, rotatably disposed detector thereby becomes a virtual two-dimensional detector. A computer with suitable software can be used in accordance with the invention to construct a two-dimensional diffraction image (scattered image) from the parameter set.

The two-dimensional application does not thereby result from a translatory motion of the detector on a movable goniometer arm, rather from the rotatability of the detector per se. The pivot point of the detector is fixed relative to the rotational motion. Preferably, the axis of rotation through which the pivot point extends, directly faces the sample. The detector path preferably extends perpendicularly to the axis of rotation. Even when the pivot point support is stationary, the inventive detector arrangement can still be used as a virtual two-dimensional detector.

A one-dimensional detector with high maximum counting rate is preferably used to permit measurement of two-dimensional diffraction patterns with improved resolution compared to a physical two-dimensional detector. Physically two-dimensional detectors are generally only suited for low radiation intensities per unit surface area.

The components of the inventive detector arrangement, i.e. a one-dimensional detector and pivotable mounting of the one-dimensional detector, are considerably less expensive than a two-dimensional detector having a detector surface which is similar to the circular surface of a one-dimensional detector swept over by the detector path.

The use of the inventive detector arrangement is advantageous for small angle scattering (SAXS), in particular, in the form of an extension of the Kratky chambers but also using a diffractometer, for texture and internal stress analysis, high-resolution diffractometry, reflectometry, out-of-plane diffractometry and monocrystal diffractometry.

The rotatability of the one-dimensional detector moreover provides a degree of freedom for a measuring arrangement, which can replace rotation of the measuring samples. This is advantageous with sample types which cannot be rotated due to their material properties.

In one particular embodiment of the inventive detector arrangement, the detector is mounted to a pivotable goniometer arm which extends in the longitudinal direction, parallel to the scattering direction. The pivot point of the detector is thereby rigidly mounted to the goniometer arm. Pivoting of the detector arm (and thereby of the position of the pivot point of the detector) basically provides access to any solid angle regions of quasi-two-dimensional detection.

In an alternative embodiment, the sample can be penetrated in transmission from a source, the source, the sample and the detector being disposed on a straight line (forward scattering). This is a typical small angle scattering geometry. The detector path of the detector can be rotated to provide two-dimensional scattering information without requiring a pivotable goniometer arm or even a physically two-dimensional detector. Orientation of a monocrystalline sample is no longer required.

In another advantageous embodiment of the inventive detector arrangement, a plurality of defined angle positions of the detector can be adjusted through rotation of the detector about the axis parallel to the scattering direction. The two most important angle positions are the detector path perpendicular to the scattering plane (plane of the source, sample and detector, i.e. the plane of the beam which impinges on the sample and of the beam which is reflected by the sample) and in the scattering plane. Additional intermediate equidistant angle positions are also preferred. The angle advance from one angle position to the next angle position is preferably just large enough, that the angle advance at the end of the detector path disposed furthest away from the pivot point and along the circumference of the swept circular surface approximately corresponds to the width of the detector path. This permits gap-less detection of a closed solid angle region.

In a another variation of this embodiment, the defined angle positions are automatically controlled and/or can be approached in a controlled manner, in particular, using a motor. This facilitates and accelerates setting of the angle positions and improves the reproducibility of the setting and the associated measurement. The defined angle positions can be approached sequentially, in particular, continuously. Sequential approach of neighboring measuring positions minimizes the time for approaching the angle positions for one measuring step. Continuous passage of the angle positions avoids gaps in the detected solid angle region of the circular surface swept by the detector path. Continuous passage can be realized quickly and with simple technical means: the time to adjust a new angle position is also the measuring time.

The pivot point of the detector through which the axis extends parallel to the scattering direction, may be disposed in the center of the detector path or at an end of the detector path. If the pivot point is disposed in the center of the detector path, the sweepable circular surface can be detected through a half-rotation of the detector path, i.e. quickly. If the pivot point is disposed at an end of the detector path, the circular surface which can be swept is particularly large. Sweeping, however, requires full rotation in this case. Optionally, the detector can count individual events to provide particularly precise measuring results which can be quickly evaluated.

The invention also includes an X-ray or neutron diffractometer comprising the above-described inventive detector arrangement. The inventive diffractometer provides a plurality of sample orientations and detector positions for various measuring methods. The diffractometer may be operated, for example, using the following steps:
(a) placing the detector at a first position in a first predetermined scattering direction;
(b) orienting the detector in a first angle position through rotation of the detector about an axis parallel to the scattering direction, and acquiring position-resolved measuring data along the detector path in the first angle position;
(c) incremental turning of the detector to at least one further angle position, and acquiring position-resolved measuring data along the detector path at this angle position;
(d) storing and processing the acquired measuring data using a predetermined algorithm.

In a variation of this method, the solid angle region which can be maximally swept by the detector path is completely covered by the various angle positions of the detector in the steps (b) through (c) for the first position of the detector at the predetermined scattering direction. This may preferably be realized when the angle advance is sufficiently small that the advance in the outer region of the detector path is smaller or equal to the width of the detector path (the detector path is actually an elongated detector surface of a certain width. Position resolution is provided in the longitudinal direction). In accordance with the invention, the detector path may also be continuously rotated. This method variant eliminates “holes” in the scanned solid angle region and ensures reliable detection of all diffraction reflexes. The processing of step (d) may produce a two-dimensional diffraction image which provides two-dimensional diffraction information using the inventive diffractometer having an inexpensive one-dimensional detector configuration.

In another variation of the method, after step (c), the detector is placed in at least one further position in a further predetermined scattering direction, and method steps (b) through (c) are repeated in this further position of the detector. Further positions of the detector or scattering directions may follow to permit inexpensive measurement of a fundamentally unlimited solid angle region. Alternatively, the detector is placed in at least one further position in a further predetermined scattering direction after step (d), and the method steps (b) through (d) are repeated in this further detector position. Further positions of the detector or scattering directions may follow which also permits inexpensive measurement of a basically unlimited solid angle region.

Using the aforementioned method, a closed solid angle region may be completely detected through the various positions and angle positions of the detector during the method. This prevents “overlooking” of important scattering information. Such a complete detection can be provided in the simplest manner through slight overlapping of the detected solid angle regions at different positions of the detector, i.e., the neighboring positions of the detector are spaced apart by less than twice the length of the detector path.

The position of the sample may be varied as an alternative to changing the position of the detector, to probe other regions of a diffraction pattern. The position of the detector may then remain fixed. In particular, after step (c), the sample is brought into at least one further position obtained through rotation and/or translation of the sample and the method steps (b) through (c) are repeated in this further sample position. Alternatively, the sample may be brought into at least one further position, obtained through rotation and/or translation of the sample, after step (d), and method steps (b) through (d) would then be repeated in this further sample position. In these variations, the sample can be rotated continuously, for example, if the sample is a filled thin glass capillary, or the positions of the sample are adjusted to the detector arm position. If the detector arm position is fixed, the penetration depth of the X-ray radiation into the sample can be selected or limited through selection of the position of the sample, in particular, for very small incidence angles of less than 3°. This limitation can be adjusted to a few tens of angstroms if the incidence angle of the X-ray radiation is set below the critical angle for total reflection. These variations may be applicable, for example, to stress measurement (chi or omega), grazing incidence diffraction (GID), depth-dependent X-ray diffraction (combination of chi, phi and omega), topography of the sample (x, y, z).

The invention also concerns an alternative method for operating an inventive diffractometer, comprising the following steps:
(a′) orienting the detector in a first predetermined angular position through rotation of the detector about an axis parallel to the scattering direction;
(b′) placing the detector at a first position in a first scattering direction, and acquiring position-resolved measuring data along the detector path in the first position;
(c′) incrementally positioning the detector in at least one further position in a further scattering direction and acquiring position-resolved measuring data along the detector path in the further position;
(d′) storing and processing the acquired measuring data using a predetermined algorithm.

Further advantages of the invention can be extracted from the description and the drawings. The features mentioned above and below may be used in accordance with the invention individually or collectively in arbitrary combination. The embodiments shown and described are not to be understood as exhaustive enumeration but have exemplary character for describing the invention.

### BRIEF DESCRIPTION OF THE DRAWINGS

The above and further advantages of the invention may be better understood by referring to the following description in conjunction with the accompanying drawings in which:

FIG. 1 shows an inventive detector arrangement in reflection geometry with the pivot point being in the center of the detector path;

FIG. 2 shows an inventive detector arrangement in reflection geometry with the pivot point being at the edge of the detector path; and

FIG. 3 shows an inventive detector arrangement in transmission geometry.

### DETAILED DESCRIPTION

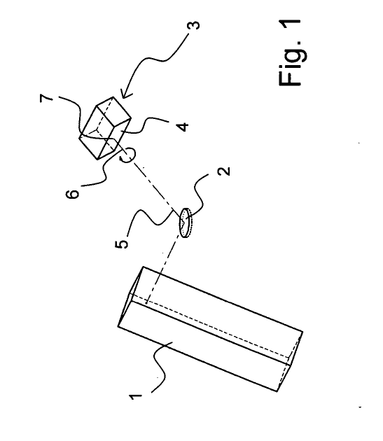

FIG. 1 shows an inventive detector arrangement comprising an X-ray source 1 which is designed as an X-ray tube, a sample 2 and a one-dimensional detector 3. The one-dimensional detector 3 has a detector path 4 which is approximately rectangular and faces the sample 2. The detector path 4 registers each impingement of an X-ray quantum, wherein the location of incidence of the X-ray quantum is registered in a position-resolved manner along the direction of the longer sides of the detector path 4. The direction of position resolution of the detector path 4, which extends parallel to the longer sides of the detector path 4, defines the orientation of the detector path 4. There is no position resolution in the direction of the short sides of the detector path 4.

The detector path 4 is oriented perpendicularly to the straight line 5 extending between the sample 2 and the detector 3. The straight line 5 extending between the sample 2 and the detector 3 is also called the scattering direction. In accordance with the invention, the detector 3 is pivotable about an axis 6. In accordance with the invention, the axis extends parallel to the scattering direction. Although the axis 6 coincides with the straight line 5 in the embodiment of FIG. 1, this is not necessary for all embodiments. The axis 6 penetrates the detector path 4 at a pivot point 7. The pivot point 7 is located in the center of the detector path 4.

The detector path 4 may sweep over a circular surface having a diameter which corresponds to the length of the longer sides of the detector path 4 by rotation of the detector 3 about the axis 6.

If, during a scattering experiment, the detector 3 is turned about the axis 6 such that all angle positions (rotational positions of the detector 3 about the axis 6) of the detector are preferably detected for identical time periods, a two-dimensional diffraction image can be produced for the swept circular surface from the registered X-ray quantums using the position resolution of the one-dimensional detector 3 and the known angular position of the detector 3 for each count.

The detector 3 is preferably mounted to a pivotable goniometer arm. A further diffraction image can be generated with the detector 3 for a further circular surface in correspondence with a solid angle region which differs from that of sample 2 through pivoting of the goniometer arm into a further position for the detector 3. An associated solid angle region of basically any size can be measured with the one-dimensional detector 3 through joining several local diffraction images, produced in this fashion, optionally with slight overlapping of neighboring local diffraction images.

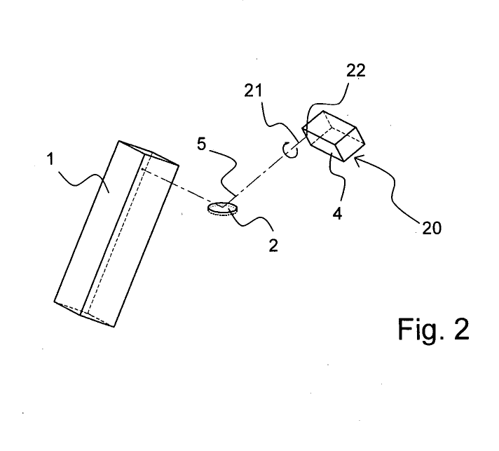

FIG. 2 shows an inventive detector arrangement similar to FIG. 1. A detector 20 can be rotated about an axis 21, wherein the axis 21 also coincides with the straight line 5 extending between the sample 2 and the detector 20. The axis 21 penetrates the detector path 4 of the detector 20 at the edge of the detector path 4 in a pivot point 22. The detector path 4 of the detector 20 can sweep a circular surface of a diameter which corresponds to twice the length of the detector path 4.

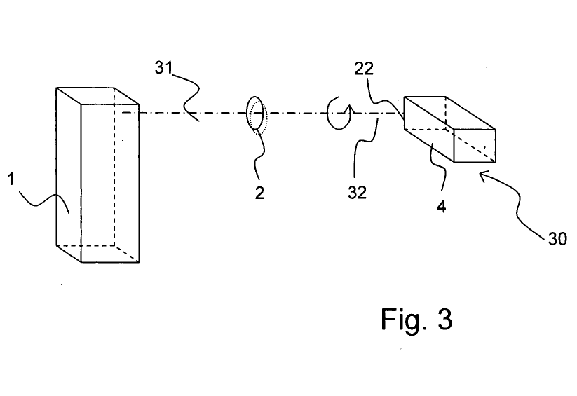

FIG. 3 shows an inventive detector arrangement in transmission geometry. This arrangement is suited, in particular, for small angle scattering. An X-ray source 1, a sample 2 and a detector 30 are disposed approximately on a straight line 31. An X-ray emitted by the X-ray source 1 penetrates the sample 2 thereby possibly producing scattering processes. The transmitted X-ray radiation partially impinges on the detector 30. The detector 30 is disposed to be pivotable about an axis 32 which coincides with the straight line 31 and thereby with the scattering direction. The axis 32 penetrates the detector path 4 of the detector 30 at the edge of the detector path 4 in the pivot point 22. The detector 30 is preferably exclusively movable via the axis 32, wherein the axis 32 is stationary. This mobility of the detector 30 is sufficient to completely detect X-ray radiation with only a slight angle deviation from the primary beam (small angle scattering) in that the detector path 4 of the detector 30 scans the solid angle region in the direct vicinity of the primary beam through rotation about the axis 32.

1. A detector apparatus for detecting X-ray or neutron radiation scattered from a sample, the detector apparatus comprising a linear particle or photon counting detector that extends along a direction substantially perpendicular to a first direction defined by a straight line extending between the sample and the detector, and wherein the detector is rotatable about an axis substantially parallel to the first direction.

2. A detector apparatus according to claim 1, wherein the detector is mounted on a pivotable goniometer arm and a longitudinal extension of the goniometer arm is parallel to the first direction.

3. A detector apparatus according to claim 1, wherein the radiation is from a radiation source and penetrates the sample such that the scattering is in transmission geometry, and wherein the source, the sample and the detector are disposed on a straight line.

4. A detector apparatus according to claim 1, wherein a plurality of defined angle positions of the detector can be adjusted through rotation of the detector about the axis parallel to the first direction.

5. A detector apparatus according to claim 4, further comprising a motor for rotating the detector to the defined angle positions.

6. A detector apparatus according to claim 4, wherein the defined angle positions are achieved sequentially.

7. A detector apparatus according to claim 1 wherein a pivot point about which the detector rotates is located substantially at the center of a longitudinal axis of the detector.

8. A detector apparatus according to claim 1, wherein a pivot point about which the detector rotates is significantly closer to one end of the detector than an opposite end along a longitudinal axis of the detector in the detection plane.

9. A diffractometer for performing a diffraction analysis of a sample material, the diffractometer comprising:
a source of particle or photon energy directed toward the sample material; and
a detector apparatus located to detect particle or photon energy redirected from the sample, the detector apparatus comprising a linear particle or photon counting detector that extends along a direction substantially perpendicular to a first direction defined by a straight line extending between the sample and the detector, and wherein the detector is rotatable about an axis substantially parallel to the first direction.

10. A method of analyzing a sample, the method comprising:
providing a linear particle or photon counting detector that extends along a direction substantially perpendicular to a first direction defined by a straight line extending between the sample and the detector, and wherein the detector is rotatable about an axis substantially parallel to the first direction;
directing particle or photon energy toward the sample material from an energy source;
detecting energy redirected from the sample with the detector positioned at a first angular orientation and generating a first detection signal;
incrementally rotating the detector to at least one further angular orientation;
detecting energy redirected from the sample with the detector at the one further orientation and generating a second detection signal; and
processing the first and second detection signals relative to the respective angular orientations of the detector.

11. A method according to claim 10, wherein the detector is incrementally rotated repeatedly to allow detection at a plurality of different angular orientations so as to provide detection across a predetermined angular range that corresponds to a desired detection area.

12. A method according to claim 10, wherein processing the detection signals comprises forming a two-dimensional diffraction image.

13. A method according to claim 10, further comprising relocating the detector and repeating the steps of repeatedly detecting energy redirected from the sample and rotating the detector to a different angular orientation.

14. A method according to claim 13, wherein the data signals from the detector are processed after each relocation of the detector.

15. A method according to claim 13, wherein rotational increments of the detector are small enough to provide continuous detector coverage across a predetermined angular range.

16. A method according to claim 10 wherein, after detecting the data signals from the sample in each of the desired rotational positions of the detector, the sample is moved to at least one further position, and the steps of detection and incremental rotation of the detector are repeated.

17. A method according to claim 16, wherein the data signals from the detector are processed after each relocation of the sample.

18. A method for analyzing a sample with a diffractometer having a detector apparatus comprising a linear particle or photon counting detector that extends along a longitudinal direction substantially perpendicular to a straight line extending between the sample and the detector, the method comprising:
orienting the detector in a first predetermined angular position by rotating the detector about an axis perpendicular to the longitudinal direction;
placing the detector at a first position in a first scattering direction and acquiring position-resolved measuring data along the detector path in the first position;
incrementing placement of the detector to at least one further position in a further scattering direction, and acquiring position-resolved measuring data along the detector path in the further position; and
storing and processing the acquired measuring data using a predetermined algorithm.
